(19) United States
(12) Patent Application Publication
(10) Pub. No.: US 2006/0005052 A1
(43) Pub. Date: Jan. 5, 2006

(54) Power management mechanism for a universal plug and play device

(76) Inventors: Bryan Y. Roe, Camas, WA (US); Ylian Saint-Hilaire, Hillsboro, OR (US); Nelson F. Kidd, Camas, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/881,367

(22) Filed: Jun. 30, 2004

(51) Int. Cl. G06F 1/26

(52) U.S. Cl. 713/300

(57) ABSTRACT

According to one embodiment, a system is disclosed. The system includes a Universal Plug and Play (UPnP) device having a power management service to indicate the power mode in which the device is operating. In addition, the system includes a monitoring system to track the power mode of the device and to power on the device whenever the device is in an Off mode.

### FIELD OF THE INVENTION

The present invention relates to the field of networking, and, more particularly to Universal Plug and Play (“UPnP”) systems.

### BACKGROUND

Universal Plug and Play (“UPnP”) provides an architecture for peer-to-peer network connectivity. UPnP-compliant devices may dynamically join a network, obtain a network address, convey their capabilities to the network and learn about the presence and capabilities of other devices on the network. UPnP control points control UPnP devices by requesting the devices to perform specified actions (“services”).

In order to target a particular device on the network, the device has to be powered on (online). However, having to maintain power for a device even when the device is not in use often results in a waste of power. Nonetheless, once the device is powered off (or offline), the device cannot be accessed on the network. Thus, when the device is needed it may not be available for accessing, resulting in the need to periodically query to determine if the device has come back online.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates one embodiment of a Universal Plug and Play (UPnP) network;

FIG. 2 is a flow chart for one embodiment of the operation of a monitoring system; and

FIG. 3 is a flow chart for another embodiment of the operation of a monitoring system.

### DETAILED DESCRIPTION

A power management mechanism for a universal plug and play device is described. In the following description, for purposes of explanation, numerous specific details are set forth in order to provide a thorough understanding of the invention. It will be apparent, however, to one skilled in the art that embodiments of the invention can be practiced without these specific details. In other instances, structures and devices are shown in block diagram form in order to avoid obscuring the invention.

Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same.

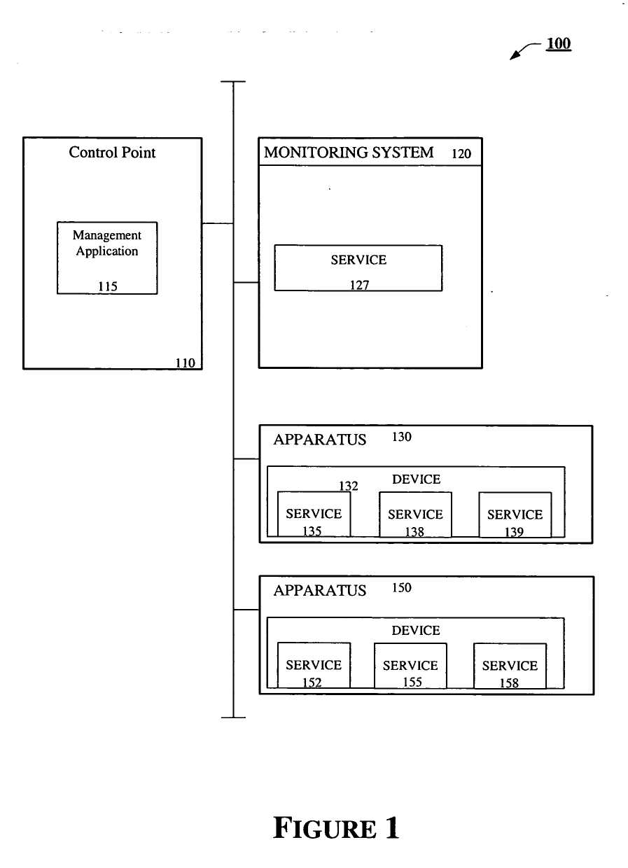

FIG. 1 illustrates one embodiment of a UPnP network 100. Network 100 includes control point 110, monitoring system 120 and apparatuses 130, and 150. Apparatuses 130 and 150 may represent a unit, such as a personal computer, a television, a digital camera, or any other suitable unit. Each apparatus may include at least one device. As used herein, a device is an object that is abstracted within an apparatus. A device may include services and/or other device objects. A service is an object that is abstracted within a device.

As shown in apparatuses 130 and 150, an apparatus may include one or more device(s), and each device may include several services. In one embodiment, apparatus 130 is a set-top box, device 132 is a digital video recorder (DVR) device, service 135 is a DVR service, and service 138 is a tuner service. In contrast, apparatus 150 may be a recordable digital video disk (DVD) apparatus that includes recording service 152 and playback service 155.

The services provided by a particular type of device differ among device types. Accordingly, a device or control point may maintain and selectively provide a listing of the service(s) and/or other information pertaining to the individual device. According to one embodiment, a device hosts an eXtensible Markup Language (XML) description document that describes the services provided by the device as well as other associated information.

Each service (135, 138, 152, 155 for example) may expose actions to UPnP control point 110 and models its state using, e.g., state variables. As a particular example, a clock service may provide the actions get_time and set_time, and may model its state using the state variable current_time.

In a further embodiment, each device includes a power management service (e.g., services 139 and 158) that indicates the power mode of the particular device. In one embodiment, the power modes include: On, Off, Suspend, and Hibernate. The actions and state variables are described by an XML service description document. The aforementioned XML description document includes a pointer to the service description documents of its associated services.

Control point 110 includes a management application 115 that is implemented to manage the various services. In one embodiment, control point 110 accesses actions of services that are embedded in disparate devices (and apparatuses). Control point 110 may be used to discover and control devices in UPnP network 100.

In one embodiment, control point 110 discovers a device, receives an XML description associated with the device, retrieves descriptions of services associated with the device based on pointers located in the description, invokes actions specified in the service descriptions, and subscribes to events issued by the services.

In the latter regard, a service will send an event to the control point when a state of the service changes. A service description may also include a list of variables that model the state of the service at run time. UPnP-compliant messages may be delivered via Hyper Text Transport Protocol (“HTTP”) or User Datagram Protocol (“UDP”) or any other of a number of protocols, possibly running over Internet Protocol (“IP”).

Monitoring system 120 is implemented to track the states of each device. In one embodiment, monitoring system 120 is a component of a router or a gateway on the UpnP. As discussed above, whenever a managed device is not in the ON mode, the device essentially not a part of the network. Monitoring system 120 ensures that commands from control point 110 get executed correctly.

In one embodiment, monitoring system 120 includes a list of all devices on network 100 and exposes functionality through UPnP such that when control point 110 wishes to bring an offline managed device back online, control point 110 issues an “On” command to monitoring system 120, along with information about which offline device is to be brought online.

According to one embodiment, service 127 on monitoring system 120 issues a Wake-On-LAN packet to the managed device that is offline in response to receiving an “On” command from control point 110. When the device is online, the device then issues an event signaling it is now online, which is directed back to control point 110.

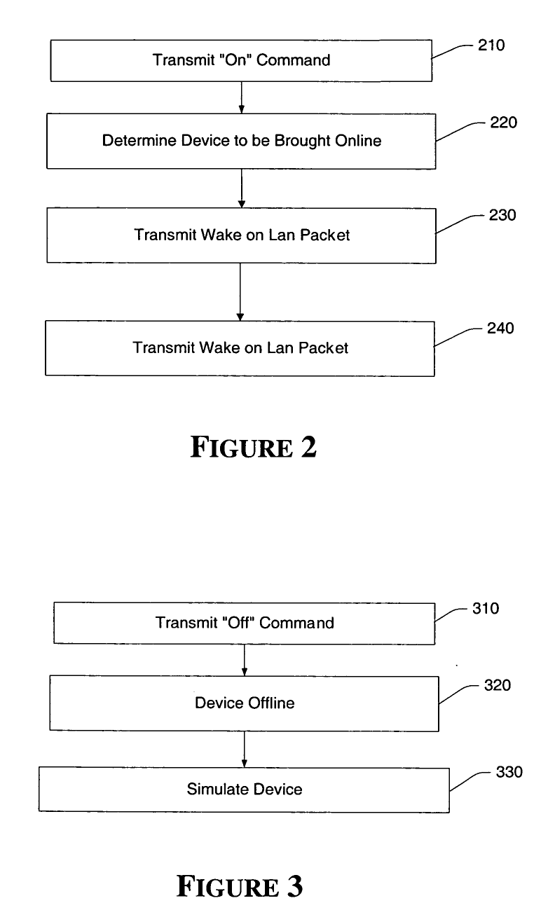

FIG. 2 is a flow chart for one embodiment of the operation of monitoring system 120 for waking up a device. At processing block 210, an “On” command is received at monitoring system 120 from control point 110 indicating a need to access a device. As discussed above, information about which offline device is to be brought online is transmitted along with the command.

At processing block 220, monitoring system 120 selects the particular offline device that is to be awakened. At processing block 230, monitoring system 120 issues a Wake-On-LAN packet to the selected offline device. At processing block 240 the device returns online and transmits an event signaling that the device is online, back to control point 110 via monitoring system 120.

According to one embodiment, control point 110 may cause devices to go offline. This may be initiated, for instance, whenever a device has not been used for a predetermined amount of time and/or is not to be used in the relatively near future. Commands to change a device to the offline state do not need to get routed through the monitoring system.

In one embodiment, such commands may simply be routed directly from control point 110 to the device that is to be switched offline. However in other embodiments, monitoring system 120 is used to issue the commands since it will able to determine when a device has actually gone offline since the device that is being taken down will not be able to issue events once in the offline state

According to one embodiment, monitoring system 120 utilizes a heartbeat signal transmitted to monitor the state of each device. When a heartbeat for a device is interrupted without prior initiation from control point 110, monitoring system 120 will reflect the offline state for that device. Note that the functionality of control point 110 and monitoring system 120 may be integrated into a single component for simplicity. According to one embodiment, monitoring system 120 may infer that a device has come back online by the resumption of the heartbeat.

FIG. 3 is a flow chart for one embodiment of the operation of monitoring system 120 for taking a device offline. At processing block 310 an “Off” command is transmitted from control point 110 to a device that is to be switched offline. As discussed above, the command may be forwarded directly to the device, or to the device via monitoring system 120. At processing block 320, the device goes offline. At processing block 330, monitoring system 120 simulates the offline device. Thus, the device appears to be online whenever there is a request to access the device.

According to a further embodiment, each apparatus (e.g. 130) has power-state information for all of the other apparatuses. In such an embodiment, network 100 does not include a monitoring system 120. Thus, the power-state information can be acquired either by, for example, peer-to-peer communication between the apparatuses.

This allows control point 110 to ask any apparatus (130 or 150) to find out about other potentially sleeping devices. When control point 110 requests to wake a device control point 120 can use the power-state information received from apparatus 130 (using a service such as 138 or 139) to directly wake apparatus 150, in a manner similar to how control point 120 would wake apparatus 150.

The above-described mechanism greatly simplifies server management for IT because it enables an administrator to easily manage servers, which often times number in the hundreds or more. In addition, the mechanism may be used to remotely track the state of a system, reboot, power down, power up, etc.

Further, power management will also be valuable in the embedded and home markets since devices in these markets typically are not always on. The mechanism enables networked devices to be able to function correctly even if the devices are not online by supporting the ability to bring devices on line when necessary.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

What is claimed is:

1. A system comprising:
a Universal Plug and Play (UPnP) device having a power management service to indicate the power mode in which the device is operating; and
a monitoring system to track the power mode of the device and to power on the device whenever the device is in an Off mode.

2. The system of claim 1 wherein the monitoring system transmits a Wake-On-LAN packet to the device to power up the device when the device is in the Off mode.

3. The system of claim 2 wherein the device transmits an event to the monitoring system to indicate that the device is online.

4. The system of claim 2 further comprising a UPnP control point, wherein the control point transmits an On command to the monitoring system to initiate the powering up of the device.

5. The system of claim 4 wherein information about the device is transmitted with the On command.

6. The system of claim 2 wherein the control point transmits an Off command to the device causing the device to enter the Off mode.

7. The system of claim 6 wherein the monitoring system simulates the device when the device is in the Off mode.

8. The system of claim 2 wherein the monitoring system transmits an Off command to the device causing the device to enter the Off mode.

9. The system of claim 1 wherein the monitoring system is implemented within a router.

10. A method comprising:
receiving a command at a monitoring station from a Universal Plug and Play (UPnP) control point indicating a request to access a UPnP device that is offline;
transmitting a Wake-On-LAN packet to the device; and
receiving an event from the device indicating that the device is online.

11. The method of claim 10 further comprising:
receiving a command at the monitoring station from the control point indicating the device that is to go offline;
transmitting a command to the device to go offline; and
simulating the offline device at the monitoring system so that the device appears to be online.

12. The method of claim 10 further comprising transmitting a heartbeat signal from the monitoring station to the device to determine the status of the device.

13. An apparatus comprising a monitoring system to track the power mode of a Universal Plug and Play (UPnP) device, to simulate the device whenever the device is offline and to bring the device online upon receiving a request to access the device.

14. The apparatus of claim 13 wherein the monitoring system transmits a Wake-On-LAN packet to the device to bring the device online.

15. The apparatus of claim 14 wherein the monitoring system receives an event from the device to indicate that the device is online.

16. The apparatus of claim 13 wherein the monitoring station transmits heartbeat signals from the monitoring station to the device to determine the status of the device.

17. A storage medium comprising content which when executed by an accessing machine, causes the accessing machine to:
receive a command at a monitoring station from a Universal Plug and Play (UPnP) control point indicating a request to access a UPnP device that is offline;
transmit a Wake-On-LAN packet to the device; and
receive an event from the device indicating that the device is online.

18. The storage medium of claim 17 further comprising content which, when executed by the accessing machine causes the accessing machine to:
receive a command at the monitoring station from the control point indicating the device that is to go offline;
transmit a command to the device to go offline; and simulate the offline device at the monitoring system so that the device appears to be online.

19. A system comprising:
a Universal Plug and Play (UPnP) device having a power management service to indicate the power mode in which the device is operating;
UPnP control point; and
a monitoring system to track the power mode of the device and to power the device online from an offline mode upon receiving a request from the control point to access the device.

20. The system of claim 19 wherein the monitoring system transmits a Wake-On-LAN packet to the device to power up the device when the device is in the Off mode.

21. The system of claim 20 wherein the device transmits an event to the monitoring system to indicate that the device is online.

22. The system of claim 19 wherein the monitoring system is implemented within a router.

23. The system of claim 19 wherein the monitoring system is implemented within a gateway.
